(19) United States
(12) Patent Application Publication
(10) Pub. No.: US 2006/0017555 A1
(43) Pub. Date: Jan. 26, 2006

(54) Method and apparatus for anticipated brake light activation

(76) Inventor: Benjamin Zimmermann, Moreno Valley, CA (US)

Correspondence Address: Jack J'maev;Suite H, 187 W. Orangehorpe Ave., Placentia, CA, 92870, US

(21) Appl. No.: 10/899,367

(22) Filed: Jul. 26, 2004

(51) Int. Cl. B60Q 1/50; B60Q 1/44

(52) U.S. Cl. 340/467; 340/479

(57) ABSTRACT

A method for activating a brake light by detecting an object proximate to a brake pedal.

### BACKGROUND

Modernly, automobiles have brake light indicators that warn other vehicles when a driver of an automobile begins to slow down. The indicator works by detecting actuation of a brake pedal. This can be done in several ways. One way that this is accomplished is by disposing an electrical switch so as to detect when the brake pedal is depressed. The electrical switch then activates a brake light when the brake pedal is depressed. Another way that this is accomplished is by disposing a pressure sensitive switch so as to sense activity in the hydraulic system that actually transmits force to braking mechanisms installed at the wheels of a car. For example, such a pressure switch is often installed at a master hydraulic cylinder. When a brake pedal is depressed, the hydraulic cylinder increases the pressure in a hydraulic line that feeds hydraulic fluid to at least one of the wheels of the car. The pressure sensor will then activate a brake light when it senses the increase in hydraulic pressure. Many other techniques can be used to determine when a brake pedal is depressed. Once it is determined that the brake pedal has been depressed, a brake light can be activated.

With an ever increasing volume of traffic on the roads today, it is clear that traffic jams are only going to get worse. One of the problems with the stop-n-go traffic that results on congested streets is that of a rear-end collision. Rear end collisions are difficult to avoid in bumper-to-bumper traffic because most motorists fail to observe minimum safe distances between their cars and the cars in front of them. It really, however, isn't the drivers fault. Because of the amount of congestion, there simply isn't enough room to actually maintain a safe following distance.

In this context, the use of a brake pedal actuation detector as a basis from activating a brake light is simply ineffective. Because of the short durations between acceleration and braking, a motorist may not have enough time to avoid a rear end collision because the brake light of the car in front of her was not perceived and acted upon as quickly as needed. What is needed is to provide a motorist that is following closely behind another car with an advance warning that the driver in the car in front of him is about to stop.

### SUMMARY

A method and apparatus activating a brake light by detecting the proximity of an object to a brake pedal. When an object is detected proximate to the brake pedal, the brake light is activated.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for activating a brake light;

FIG. 2 is a flow diagram that depicts one alternative method for detecting an object;

FIG. 3 is a flow diagram that depicts yet another alternative method for detecting an object by sensing the amount of electromagnetic radiation arriving at a brake pedal;

FIG. 4 is a flow diagram that depicts yet another alternative method for detecting an object by sensing the amount of electromagnetic radiation emitted from a brake pedal;

FIG. 5 is a flow diagram that depicts one example method for sonically detecting an object poised to depress a brake pedal;

FIG. 6 is a pictorial diagram of one example embodiment of a brake light activation apparatus;

FIG. 7 is a pictorial diagram that depicts one alternative embodiment of a proximity detector;

FIG. 8A is a pictorial diagram that depicts one alternative embodiment of a proximity detector that includes an illumination source and a detector that are spatially diverse;

FIG. 8B is a pictorial diagram that depicts an alternative application of a proximity detector that includes a radiator and a detector that are spatially diverse; and

FIGS. 9A and 9B are pictorial diagrams that depict alternative embodiments of a brake light activation apparatus that uses sonic energy to detect an object.

### DETAILED DESCRIPTION

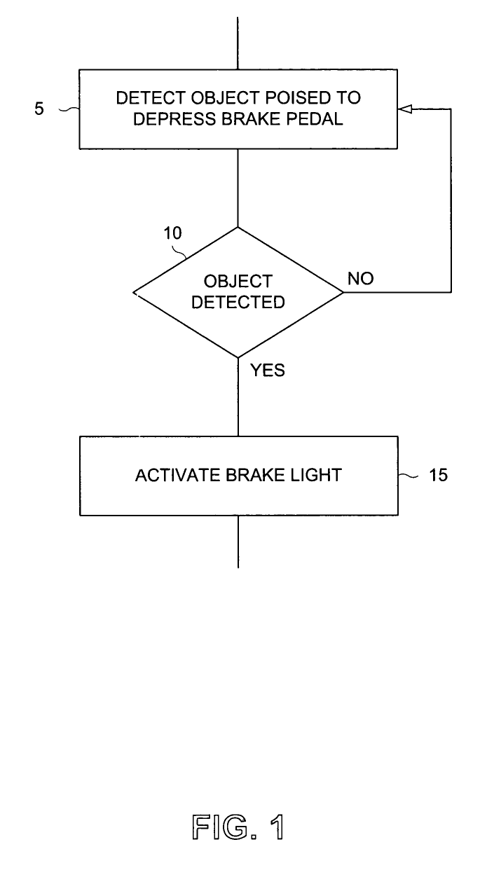

FIG. 1 is a flow diagram that depicts one example method for activating a brake light. According to this example method, a brake light is activated by detecting an object poised to depress a brake pedal (step 5). When an object is detected (step 10), the brake light is activated (step 15). It should be appreciated that the present method is applicable in an automotive environment wherein an object to be detected includes the foot of an operator that is about to press the break pedal. Typically, the operator of an automobile will begin to move their foot toward the break pedal when the operator perceives a need to slow the vehicle. According to known art, the brake light of the vehicle is not activated until the break pedal is actually depressed. It can be appreciated that several tenths of a second are lost from the time the operator perceives a need to slow the vehicle down to the time when the brake light is actually activated. These several tenths of a second may prevent a rear-end collision by providing additional reaction time to the operator of an automobile following a first automobile.

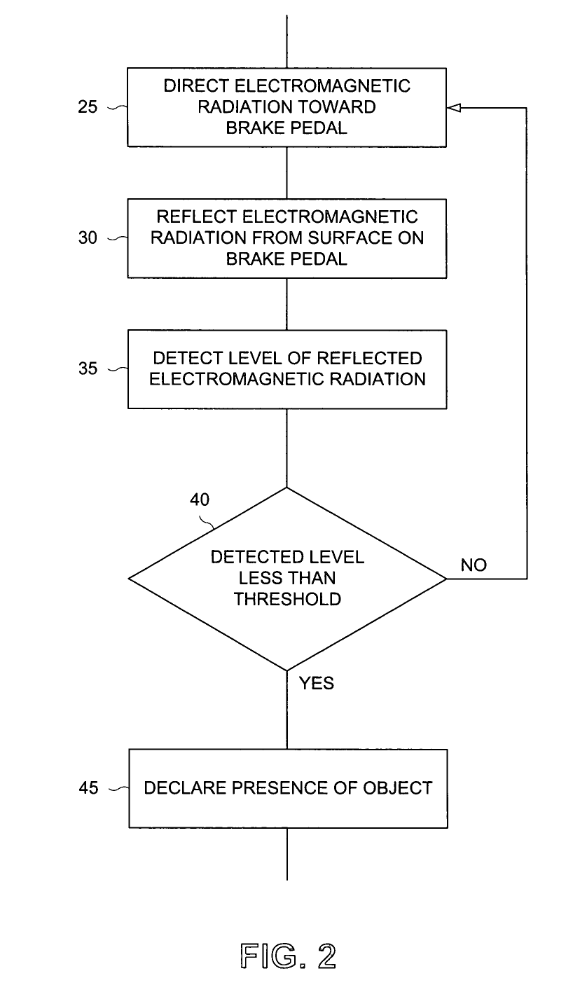

FIG. 2 is a flow diagram that depicts one alternative method for detecting an object. According to this alternative method, an object is detected by directing electromagnetic radiation toward a break pedal (step 25). A portion of the electromagnetic radiation incident on a surface of the break pedal is then reflected (step 30). The level of reflected electromagnetic radiation is then detected (step 35). When the detected level of electromagnetic radiation is less than or greater than a pre-established threshold (step 40), the presence of an object is declared (step 45). According to one illustrative use case, electromagnetic radiation can be directed toward a brake pedal in the form of light. For example, an illumination source can be disposed above the brake pedal such that an object passing between the illumination source and the brake pedal will vary the amount of electromagnetic radiation (e.g. light) that actually reaches the surface of the brake pedal. Given that a detector is disposed to detect the amount of electromagnetic radiation that is reflected, a sense path is established through the points coincident with the illumination source, an incident surface of the brake pedal and the detector. It follows that the amount of radiation reflected from the incident surface of the brake pedal will also be reduced. Accordingly, when the amount of reflected electromagnetic radiation falls below the pre-established threshold, it can be inferred that an object is moving toward the break pedal in order to actually depress the brake pedal. According to this variation of the present method, it can also be appreciated that when an object is moved between the source of illumination and the brake pedal, the object itself can act to reflect electromagnetic radiation back to the detector. According to this variation of present method, the amount of electromagnetic radiation reflected may actually increase because the object introduced into the sensing path is closer than the break pedal and/or maybe more reflective than the brake pedal itself.

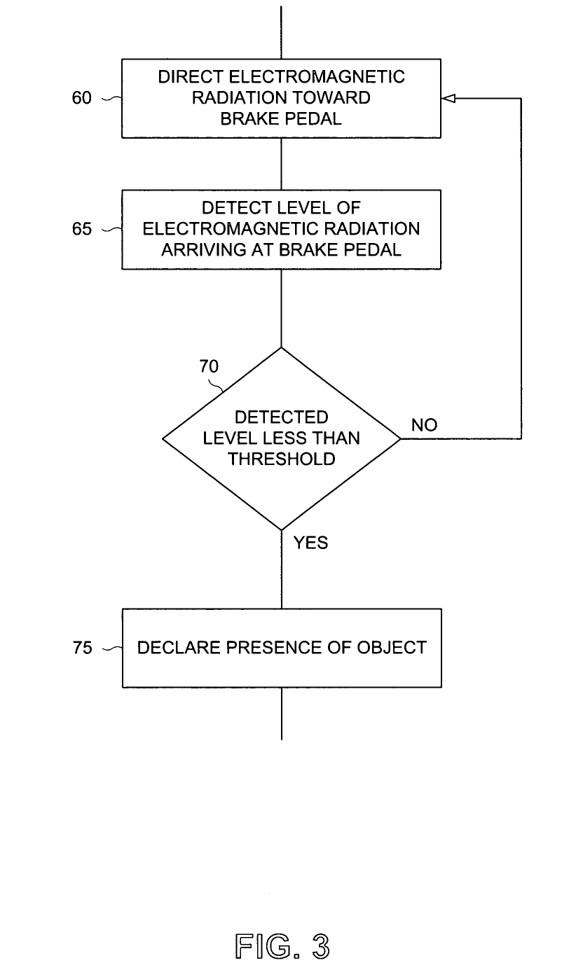

FIG. 3 is a flow diagram that depicts yet another alternative method for detecting an object by sensing the amount of electromagnetic radiation arriving at a brake pedal. According to this alternative method, an object is detected by directing electromagnetic radiation toward the brake pedal (step 60). The amount of electromagnetic radiation arriving at the brake pedal is then detected (step 65). When the detected level is less than a pre-established threshold (step 70), the presence of an object is declared (step 75). According to this variation of the present method, an illumination source may be used to direct electromagnetic radiation (e.g. light) toward the brake pedal. A detector disposed on or proximate to an incident surface of the break pedal is used to detect the amount of electromagnetic radiation arriving from the illumination source. The object disposed between the illumination source and the detector will reduce the amount of electromagnetic radiation arriving at the detector, which is a delta that can be detected.

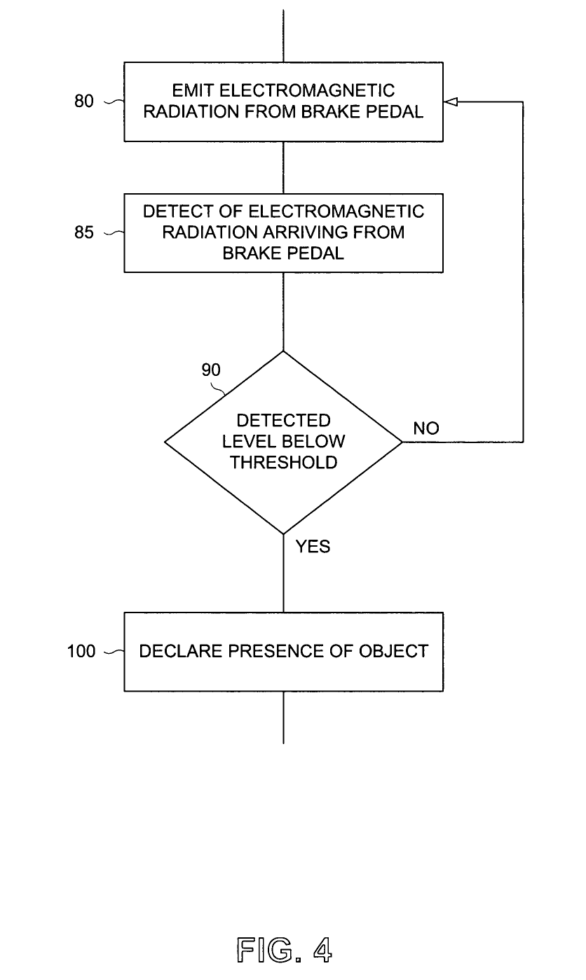

FIG. 4 is a flow diagram that depicts yet another alternative method for detecting an object by sensing the amount of electromagnetic radiation emitted from a brake pedal. According to this variation of the present method, electromagnetic radiation is emitted from the brake pedal (step 80). The amount of electromagnetic radiation arriving from the brake pedal is then detected (step 85). When the amount of detected electromagnetic radiation falls below a pre-established threshold (step 90), the presence of an object is declared (step 100). This variation of the present method can be applied where the illumination source is disposed on or proximate to an incident surface of the break pedal and the detector is disposed in a position to detect the presence of an object moving toward the brake pedal.

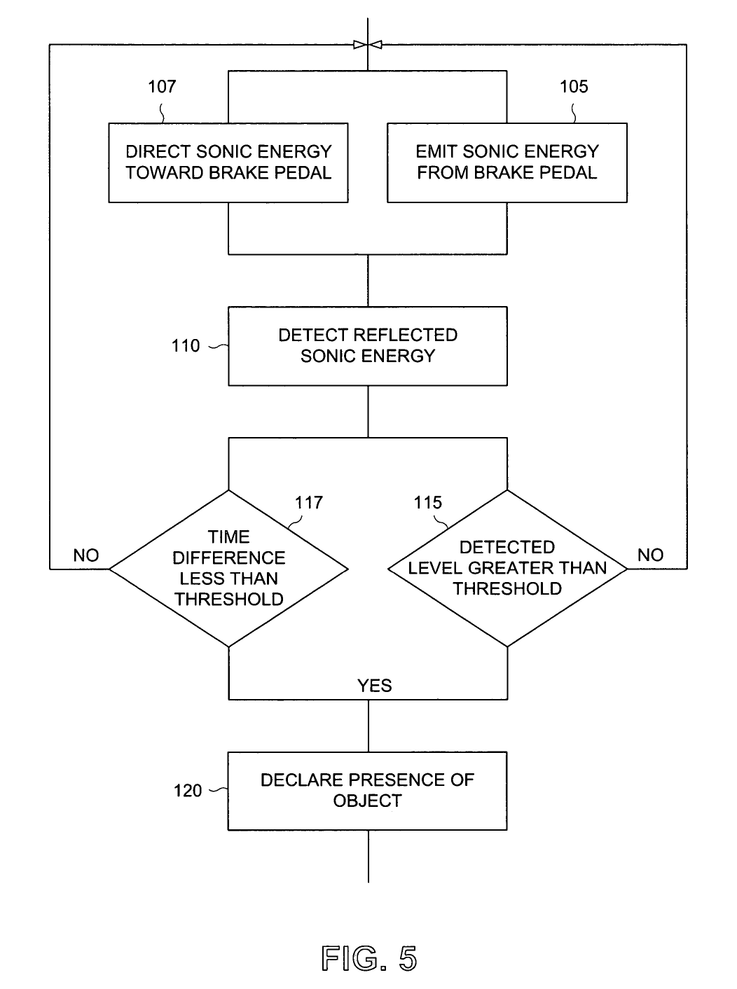

FIG. 5 is a flow diagram that depicts one example method for sonically detecting an object poised to depress a brake pedal. According to this example method, sonic energy is directed either toward (step 107) a brake pedal or is emitted from a brake pedal (step 105). In either case, the amount of reflected sonic energy is detected (step 110). When the amount of reflected sonic energy is greater than a pre-established threshold (step 115), the presence of an object is declared (step 120). According to another variation of the present method, the time difference from the time when a pulse of sonic energy is emitted to the time when a pulse of sonic energy is detected is compared to a pre-established threshold. Accordingly, when the time difference is less than the pre-established threshold (step 117), the presence of an object is declared (step 120). These variations of the present method can be applied by disposing a sonic proximity detector either on the brake pedal itself or at a position where the sonic proximity detector can detect the presence of an object poised to depress the brake pedal. A sonic proximity detector typically includes a sonic radiator and a sonic detector. Typically, the sonic detector is situated in a manner to receive sonic energy from a direction substantially opposite to a direction of the emissions of the sonic radiator.

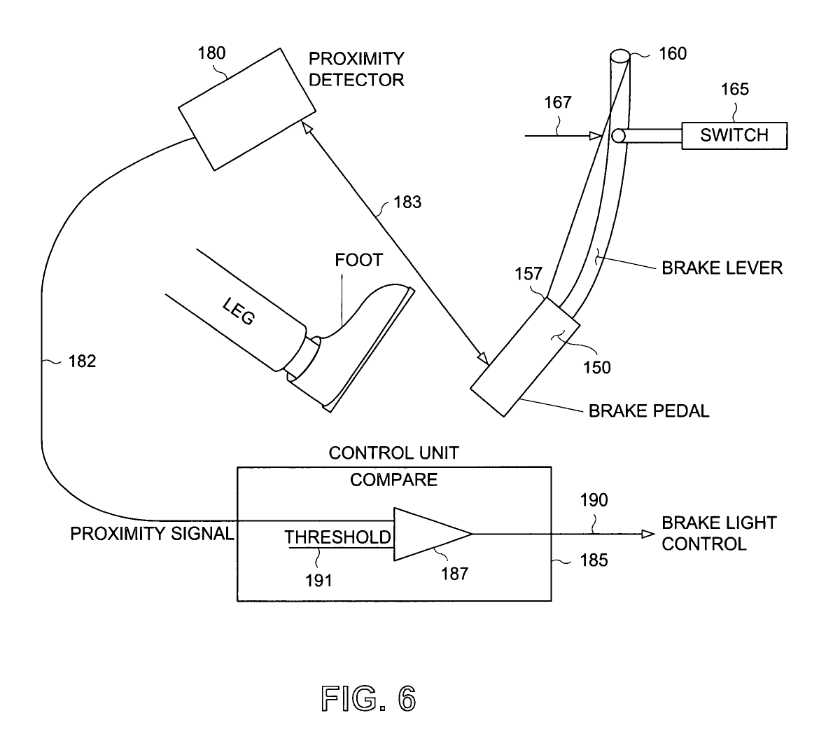

FIG. 6 is a pictorial diagram of one example embodiment of a brake light activation apparatus. According to this example embodiment, a brake light activation apparatus comprises a proximity detector 180 and a control unit 185. According to this example embodiment, the proximity detector 180 generates a proximity signal 182. The proximity signal 182 varies according to the presence and position of an object disposed between the proximity detector 180 and the brake pedal 155. For example, the proximity signal 182 will vary as a foot of an automobile operator moves into a sensing path 183 established between the proximity detector 180 and an incident surface 157 of the brake pedal 155. Generally, the brake pedal 155 is disposed at the end of a brake lever 160. Up until now, activation of a brake light was accomplished by means of a switch 165 that would sense movement of the brake lever 160 when the brake pedal 155 was depressed. Accordingly, movement 167 of the brake lever 160 would actuate the switch 165. In the present apparatus, the control unit 185 generates a brake light control signal 190 that controls activation of a brake light.

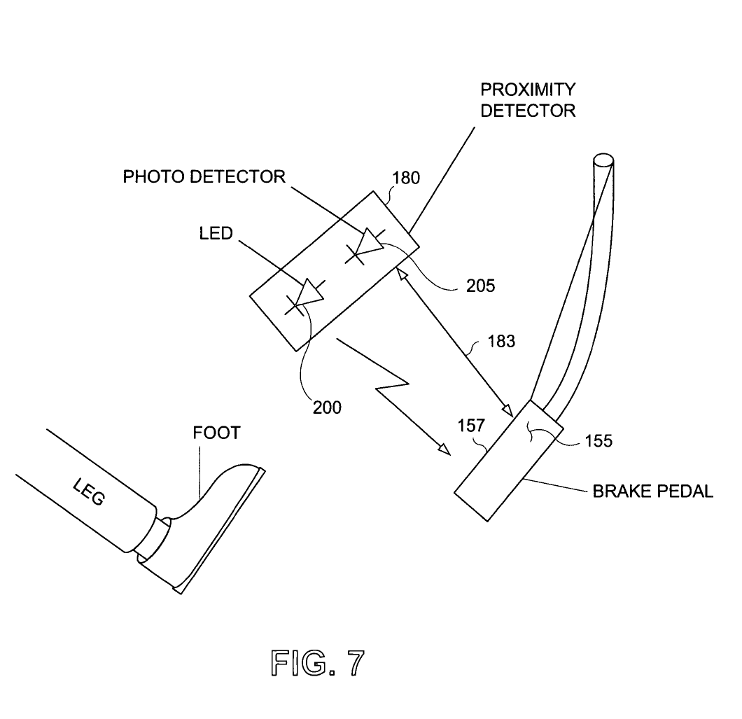

FIG. 7 is a pictorial diagram that depicts one alternative embodiment of a proximity detector. According to this alternative embodiment, a proximity detector 180 comprises an electromagnetic radiator 200 and an electromagnetic detector 205. According to this alternative embodiment, the electromagnetic radiator 200 is disposed to direct electromagnetic radiation toward an incident surface 157 on a brake pedal 155. According to this alternative embodiment, the electromagnetic detector 205 is disposed to receive electromagnetic radiation reflected from the incident surface 157 of the brake pedal 155 or from an object disposed between the proximity detector 180 and the brake pedal 155.

FIG. 6 further illustrates that the control unit 185 includes a comparator 187. The comparator 187 compares the value of the proximity signal 182, generated by the proximity detector 180, to a pre-established threshold 191. According to one example embodiment where the proximity detector 180 includes an electromagnetic detector 205 disposed to receive reflected electromagnetic energy from at least one of the incident surface 157 of the brake pedal 155 or from an object disposed between the proximity detector 180 and the brake 155, the comparator 187 is structured to detect when the value of the of proximity signal 182 is either greater than or less than the pre-established threshold 191.

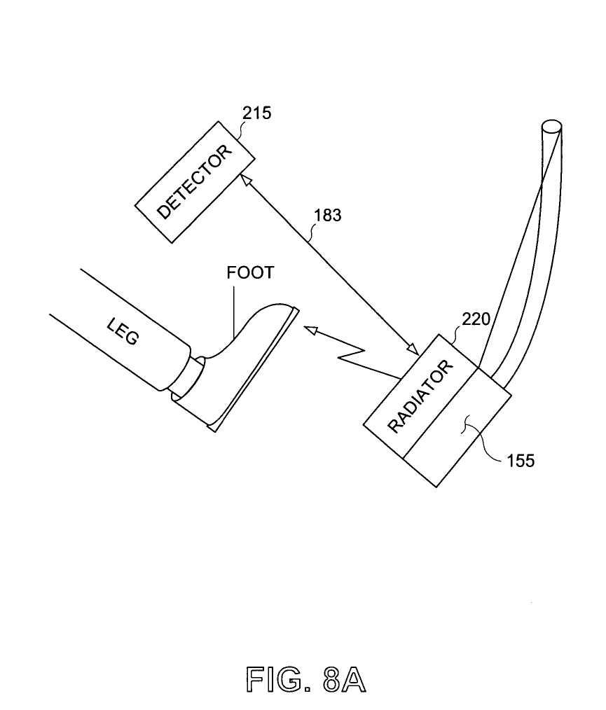

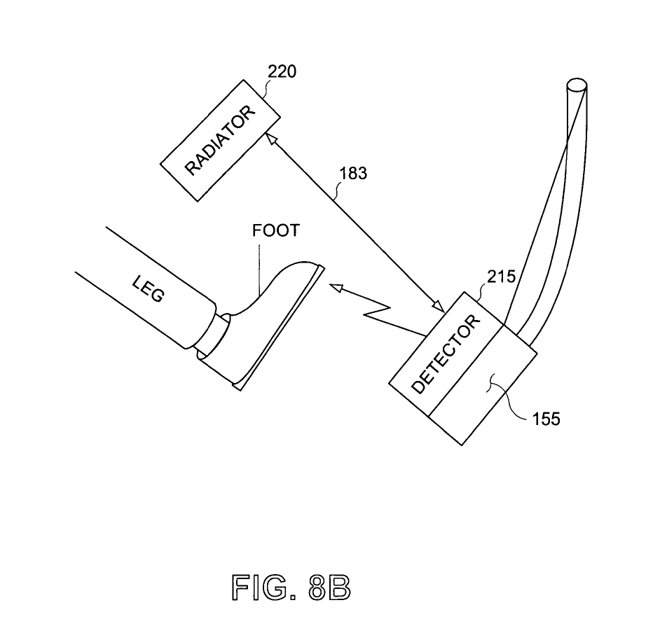

FIG. 8A is a pictorial diagram that depicts one alternative embodiment of a proximity detector that includes an illumination source and a detector that are spatially diverse. According to this alternative embodiment, the proximity detector 180 includes two separate assemblies: a detector 215; and a radiator 220. According to this alternative embodiment, the detector 215 and the radiator 220 are disposed in a manner such as to establish a sensing path between the two assemblies. The sensing path, according to one illustrative use case, is positioned to detect the presence of an object disposed to depress the brake pedal 155. It should be noted that the radiator 220, according to one alternative embodiment, is disposed on the brake pedal 155 and oriented to direct electromagnetic radiation away from the brake pedal 155 in a general direction so as to detect the approach of an object. For example, upward and away from the brake pedal 155 so as to detect the presence of a human foot poised to depress the brake pedal 155. According to this alternative embodiment, the detector 215 is disposed at the opposite end of a sensing path so as to detect the amount of electromagnetic radiation received from the radiator 220. When an object crosses the sensing path, the detector 215 will detect a drop in the level of the detected electromagnetic radiation.

FIG. 6 further illustrates that the control unit 185 includes a comparator 187 structured to detect a reduction in level of a proximity signal 182 generated by the detector 215 of this alternative embodiment that includes spatially diverse radiator 220 and detector 2154 assemblies.

FIG. 8B is a pictorial diagram that depicts an alternative application of a proximity detector that includes a radiator and a detector that are spatially diverse. This alternative embodiment can also be applied by disposing the detector 215 on the brake pedal 155 and disposing the radiator 220 above the brake pedal so as to establish a sensing path 183 that is positioned to detect an object that is poised to depress the brake pedal 155.

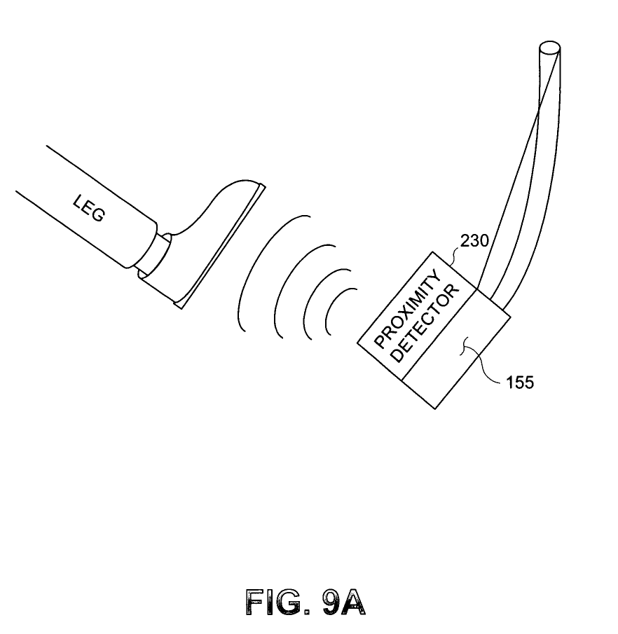

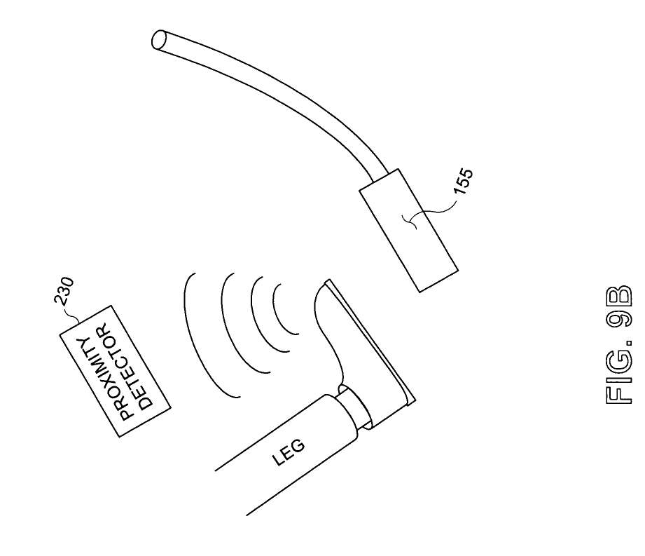

FIGS. 9A and 9B are pictorial diagrams that depict alternative embodiments of a brake light activation apparatus that uses sonic energy to detect an object. According to one alternative embodiment, an apparatus for activating a brake light includes a proximity detector 230 that comprises a sonic proximity detector. It can be appreciated that the sonic proximity detector emits sonic energy in a predetermined direction and then generates a proximity signal according to sonic energy received from that direction. According to one alternative embodiment of a sonic proximity detector, as the level of received sonic energy increases there is an inference that an object is becoming closer to the sonic proximity detector. According to one alternative embodiment, the sonic detector emits a pulse of sonic energy and measures the time from the emission of the pulse to the time that a reflected pulse of sonic energy is received. As the time between emission and detection decreases, there is an inference that there is an object that is becoming closer to the sonic proximity detector.

According to one embodiment, the sonic proximity detector is disposed on a brake pedal 155 and is oriented so as to detect the approach of an object toward the brake pedal 155. According to another alternative embodiment, the sonic proximity detector 230 is oriented above the brake pedal 155 so as to detect the approach of an object toward the brake pedal 155. In either of these alternative embodiments, the proximity detector 230 will generate a proximity signal that reflects the range to an object. The control unit 180 in each of these alternative embodiments includes a comparator 187 structured to generate a brake light control signal 190 when the level of the proximity signal generated by the sonic proximity detector indicates that the range to an object has decreased below a pre-established threshold.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A method for activating a brake light comprising:
detecting an object poised to depress a brake pedal; and
activating the brake light when the object is detected.

2. The method of claim 1 wherein detecting an object comprises:
directing electromagnetic radiation toward the brake pedal;
reflecting the electromagnetic radiation that is either incident on the break pedal or incident on an object;
detecting the reflected electromagnetic radiation; and
declaring the presence of an object according to an amount of detected reflected electromagnetic radiation.

3. The method of claim 1 wherein detecting an object comprises:
directing electromagnetic radiation toward the brake pedal;
detecting the amount of electromagnetic radiation arriving at the brake pedal;
declaring the presence of an object when the amount detected electromagnetic radiation falls below a pre-established level.

4. The method of claim 1 wherein detecting an object comprises:
emitting electromagnetic radiation from the brake pedal;
detecting the amount of electromagnetic radiation arriving from the brake pedal;
declaring the presence of an object when the amount detected electromagnetic radiation falls below a pre-established level.

5. The method of claim 1 wherein detecting an object comprises:
emitting sonic energy from the break pedal;
detecting any reflected sonic energy; and
declaring the presence of an object according to at least one of the amount of detected sonic energy received or the difference in time from the emission of the sonic energy to the receipt of reflect sonic energy.

6. The method of claim 1 wherein detecting an object comprises:
directing sonic energy to the break pedal;
detecting any reflected sonic energy; and
declaring the presence of an object according to at least one of the amount of detected sonic energy received or the difference in time from the emission of the sonic energy to the receipt of reflect sonic energy.

7. A brake light activation apparatus comprising:
proximity detector situated to detect an object poised to depress a brake pedal and that is capable of generating a proximity signal according to the position of an object relative to the brake pedal; and
control unit generates a brake light signal according to the proximity signal.

8. The brake light activation apparatus of claim 7 wherein the proximity detector comprises:
electromagnetic radiator capable of directing electromagnetic radiation toward a brake pedal having a surface; and
electromagnetic detector capable of generating a proximity signal according to an amount of electromagnetic radiation reflected either from the brake pedal surface or from the surface of an object
wherein the control unit generates a brake light signal when the level of the proximity signal is either greater than or less than a pre-established threshold.

9. The brake light activation apparatus of claim 7 wherein the proximity detector comprises:
electromagnetic radiator capable of directing electromagnetic radiation toward a brake pedal having a surface; and
electromagnetic detector capable of generating a proximity signal according to an amount of electromagnetic radiation arriving at the brake pedal surface
wherein the control unit generates a brake light signal when the level of the proximity signal is either greater than or less than a pre-established threshold.

10. The brake light activation apparatus of claim 7 wherein the proximity detector comprises:
electromagnetic radiator capable of directing electromagnetic radiation away from a brake pedal; and
electromagnetic detector capable of generating a proximity signal according to an amount of electromagnetic radiation received from the electromagnetic radiator
wherein the control unit generates a brake light signal when the level of the proximity signal is less than a pre-established threshold.

11. The brake light activation apparatus of claim 7 wherein the proximity detector comprises:
sonic radiator situated on a brake pedal capable of directing sonic energy away from the brake pedal; and
sonic detector situated on the brake pedal capable of generating a proximity signal according reflected sonic energy received by the sonic detector and wherein the control unit generates a brake light signal when the proximity signal generated by the detector indicates that there is an object closer than a pre-established distance.

12. The brake light activation apparatus of claim 7 wherein the proximity detector comprises:
sonic radiator situated proximate to a brake pedal capable of directing sonic energy toward the brake pedal; and
sonic detector situated proximate to the brake pedal capable of generating a proximity signal according reflected sonic energy received by the sonic detector and wherein the control unit generates a brake light signal when the proximity signal generated by the detector indicates that there is an object closer than a pre-established distance.
